(19) United States
(12) Patent Application Publication
(10) Pub. No.: US 2014/0240495 A1
(43) Pub. Date: Aug. 28, 2014

(54) SURVEILLANCE DEVICE AND CONTROL METHOD OF THE SAME

(71) Applicant: JVC KENWOOD Corporation, Yokohama-shi (JP)

(72) Inventor: Tadao SHINYA, Yokohama-shi (JP)

(73) Assignee: JVC KENWOOD Corporation, Yokohama-shi (JP)

(21) Appl. No.: 14/189,417

(22) Filed: Feb. 25, 2014

(30) Foreign Application Priority Data
Feb. 25, 2013 (JP) 2013-034175

(51) Int. Cl. H04N 5/235

(52) U.S. Cl. CPC H04N 5/2352
USPC 348/143

(57) ABSTRACT

A drive controller is configured to control an imaging unit so that a subject is imaged at a first exposure mode and imaged at a second exposure mode. A gain controller is configured to set equal to each other luminance amplitudes of a first and second image signals due to the difference in exposure time period of a first luminance signal obtained by imaging the subject in the first exposure mode and a second luminance signal obtained by imaging the subject in the second exposure mode. A determination unit is configured to detect a change between each frame of high-frequency components included in the first and second luminance signals whose luminance amplitudes are set equal to each other and to determine that the image of a surveillance area has changed when an amount of a detected change is equal to or larger than a predetermined value.

### CROSS REFERENCE TO RELATED APPLICATION

This application is based upon and claims the benefit of priority under 35U.S.C.§119 from Japanese Patent Application No. 2013-034175, filed on Feb. 25, 2013, the entire contents of which are incorporated herein by reference.

### BACKGROUND

The present disclosure relates to a surveillance device and a control method of the same.

Some surveillance devices perform surveillance under low-illumination environments like a parking lot at night by imaging a subject in a predetermined surveillance area with a surveillance camera.

In this type of a surveillance device, generally, the exposure time period of an imaging device is set longer than usual and is set to a time period of a plurality of frames, for example. This can provide signals of bright and sharp images although the frame rate is lowered.

In this case, such signals of sharp images can be obtained if the subject completely remains stationary. However, if the subject moves, the image of the subject blurs, and the outline of the moving subject cannot be accurately recognized.

Japanese Patent Laid-open Publication No. 2001-281718 (Patent Literature 1) describes a surveillance device which detects high-frequency components of an image signal obtained through long-period exposure and, when the high-frequency components are reduced, determines that the image of the surveillance area includes a change and proceeds to a normal exposure mode (short-period exposure).

### SUMMARY

The detection method described in Patent Literature 1 can detect a change in the image of the surveillance area if the entire subject moves.

However, when the background remains stationary in the subject and a certain object enters the surveillance area and moves, the outline of the moving object blurs because of long-period exposure, and the change in high-frequency components is small. Such changes in the image of the surveillance area cannot be detected in some cases.

Accordingly, there is a demand for increasing the accuracy in detecting a change in the image of the surveillance area.

An object of the embodiments is to provide a surveillance device and a control method of the same which can provide a higher accuracy in detecting a change in the image of the surveillance area under low-illumination environments.

A first aspect of the embodiments provide a surveillance device comprising: an imaging unit including an imaging device; a drive controller configured to control the imaging unit so that a subject is imaged at a first exposure mode in which the imaging device is exposed for a first exposure time period and imaged at a second exposure mode in which the imaging device is exposed for a second exposure time period that is longer than the first exposure time period; a gain controller configured to control a gain of any one of a first luminance signal of a first image signal obtained by imaging the subject in the first exposure mode and a second luminance signal of a second image signal obtained by imaging the subject in the second exposure mode so as to set equal to each other luminance amplitudes of the first and second image signals due to a difference in exposure time period; and a determination unit configured to detect a change between each frame of high-frequency components included in the first and second luminance signals whose luminance amplitudes are set equal to each other by the gain controller and to determine that the image of a surveillance area has changed when an amount of a detected change is equal to or larger than a predetermined value.

A second aspect of the embodiments provide a surveillance device comprising: an imaging unit including an imaging device; a drive controller configured to control the imaging unit so that a subject is imaged at a first exposure mode in which the imaging device is exposed for a first exposure time period and imaged at a second exposure mode in which the imaging device is exposed for a second exposure time period that is longer than the first exposure time period; a gain controller configured to control a gain of any one of a first luminance signal of a first image signal obtained by imaging the subject in the first exposure mode and a second luminance signal of a second image signal obtained by imaging the subject in the second exposure mode so as to set equal to each other luminance amplitudes of the first and second image signals due to a difference in exposure time period; a difference detector configured to detect a difference between adjacent frames in the first and second luminance signals whose luminance amplitudes are set equal to each other by the gain controller; and a high-frequency detection and determination portion configured to detect an amount of high-frequency components based on the difference detected by the difference detector and to determine that the image of a surveillance area has changed when the amount of high-frequency components is equal to or larger than a predetermined threshold value.

A third aspect of the embodiments provide a control method of a surveillance device comprising: imaging a subject in a first exposure mode at which an imaging device is exposed for a first exposure time period and a second exposure mode at which the imaging device is exposed for a second exposure time period that is longer than the first exposure time period; adjusting a gain of any one of a first luminance signal of a first image signal obtained by imaging the subject at the first exposure mode and a second luminance signal of a second image signal obtained by imaging the subject at the second exposure mode so that luminance amplitudes of the first and second image signals due to a difference in exposure time period are equal to each other; and detecting a change between each frame of high-frequency components included in the first and second luminance signals whose luminance amplitudes are set equal to each other and determining that the image of a surveillance area has changed when an amount of a detected change is equal to or larger than a predetermined value.

### BRIEF DESCRIPTION OF THE DRAWINGS

FIG. 1 is a block diagram illustrating a surveillance device of a first embodiment.

FIG. 2 is a block diagram illustrating a concrete configuration of a determination unit 30 in FIG. 1.

FIG. 3 is a time chart illustrating the operation of the surveillance device of the first embodiment when it is assumed that the surveillance device of the first embodiment operates only in a long-exposure mode.

FIG. 4 is a diagram illustrating examples of the surveillance area image and luminance signal waveform when it is assumed that the surveillance device of the first embodiment operates only in the long-exposure mode.

FIG. 5 is a diagram illustrating other examples of the surveillance area image and luminance signal waveform when it is assumed that the surveillance device of the first embodiment operates only in the long-exposure mode.

FIG. 6 is a time chart showing the operation of the surveillance device of the first embodiment.

FIG. 7A is a diagram showing examples of the surveillance area image and luminance signal waveform for explaining the operation of the surveillance device of the first embodiment.

FIG. 7B is a diagram showing examples of the surveillance area image and luminance signal waveform for explaining the operation of the surveillance device of the first embodiment.

FIG. 8 is a diagram showing other examples of the surveillance area image and luminance signal waveform for explaining the operation of the surveillance device of the first embodiment.

FIG. 9 is a block diagram illustrating a surveillance device of a second embodiment.

FIG. 10 is a block diagram illustrating a concrete configuration of a determination unit 31 of FIG. 9.

FIG. 11 is a time chart showing the operation of the surveillance device of the second embodiment.

FIG. 12 is a diagram showing examples of the luminance signal waveform and examples of the difference between the luminance signal waveforms of adjacent frames for explaining the operation of the surveillance device.

### DETAILED DESCRIPTION

Hereinafter, a description is given of a surveillance device and a control method of the surveillance device of each embodiment with reference to the accompanying drawings.

### First Embodiment

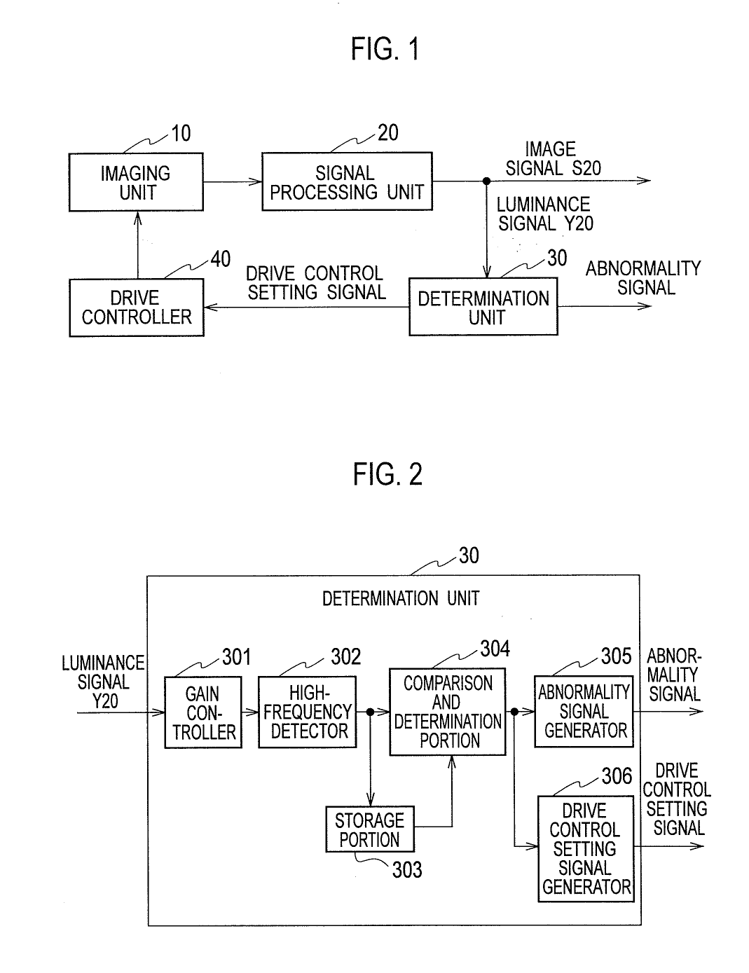

In FIG. 1, an imaging unit 10 includes an imaging device and a lens for imaging a subject. The imaging device is a CCD or CMOS, for example. The imaging unit 10 images a subject with the exposure time period of the imaging device set to a normal time period or a long time period under control of a drive controller 40. Herein, the normal time period is a time period within one frame, and the long time period is a time period over a plurality of frames.

The imaging mode with the exposure period time set to the normal time period within one frame is referred to as a short-exposure mode, and the imaging mode with the exposure period time set to the long time period over a plurality of frames is referred to as a long-exposure mode.

The imaging signal outputted from the imaging unit 10 is inputted to a signal processing unit 20. The signal processing unit 20 is configured to generate three primary color RGB signals corresponding to individual pixels by an interpolation process called demosaic when the imaging device is a single-plate element including a color filter array, and a color signal of any one of red (R), green (G), and blue (B) is taken out from each pixel.

The signal processing unit 20 generates a luminance signal and color difference signals based on the RGB signals and outputs the generated signals as an image signal S20.

The imaging device of the imaging unit 10 may be a three-plate element including imaging devices individually for R, G, and B. In this case, the signal processing unit 20 generates a luminance signal Y20 and difference signals based on the RGB signals outputted from the imaging devices for R, G, and B and outputs the generated signals as the image signal S20.

The luminance signal Y20 outputted from the signal processing unit 20 is inputted into a determination unit 30. The determination unit 30 is configured to detect a change in the image of the surveillance area based on the luminance signal Y20 as described later.

In this embodiment, the state where a subject within the surveillance area remains stationary and it is determined that the image of the surveillance area has not changed is considered normal. The state where a moving object such as a person enters the surveillance area and it is determined that the image of the surveillance area has changed is considered abnormal.

When determining based on a change in the image of the surveillance area that there is an abnormality, the determination unit 30 generates an abnormality signal and outputs the generated abnormality signal to the outside. Moreover, the determination unit 30 generates a drive control setting signal and supplies the same to a drive controller 40 if necessary.

Based on the drive control setting signal, the drive controller 40 changes the exposure mode of the imaging unit 10 from the long-exposure mode to the short-exposure mode in some cases.

As illustrated in FIG. 2, the determination unit 30 includes a gain controller 301, a high-frequency detector 302, a storage portion 303, a comparison and determination portion 304, an abnormality signal generator 305, and a drive control setting signal generator 306. The concrete operation of the determination unit 30 illustrated in FIG. 2 is described in detail later.

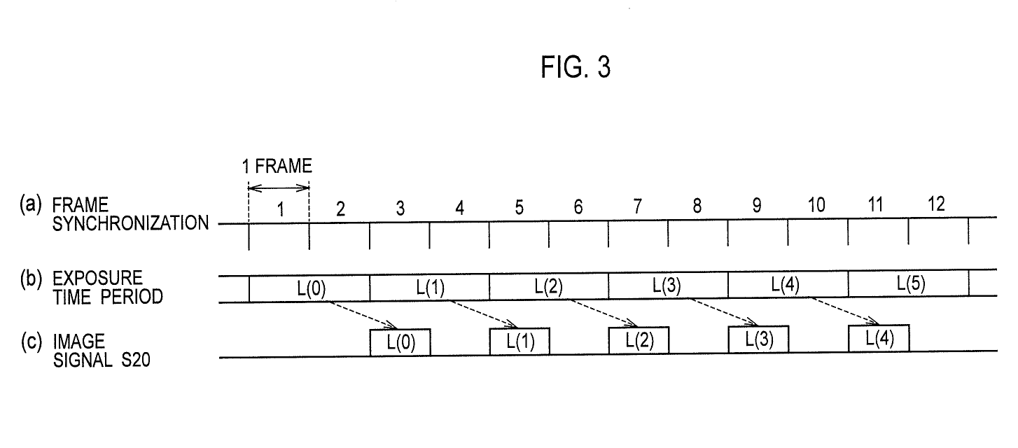

Prior to the description about the operation of the surveillance device of the first embodiment, with reference to FIGS. 3 to 5, a description is given of the operation of the surveillance device illustrated in FIG. 1 when it is assumed that the surveillance device operates only in the long-exposure mode.

In FIG. 3, (a) shows frame synchronization, and each frame is given a frame number of 1 to 12. In FIG. 3, (b) shows the exposure time period, and herein, the exposure time period of the long-exposure mode is set to a time period of two frames. In FIG. 3, (c) shows the image signal S20 outputted from the signal processing unit 20.

As illustrated in (b) and (c) of FIG. 3, an image signal L(0) obtained through exposure for a time period of two frames including the frames 1 and 2 is outputted at the time of the frame 3, and an image signal L(1) obtained through exposure for a time period of two frames including the two frames 3 and 4 and is outputted at the time of the frame 5. In a similar manner, image signals L(2), L(3), and L(4) are outputted at the times of the frames 7, 9, and 11, respectively.

The image signals L(0) to L(4) are image signals of the frames constituting the image signal S20.

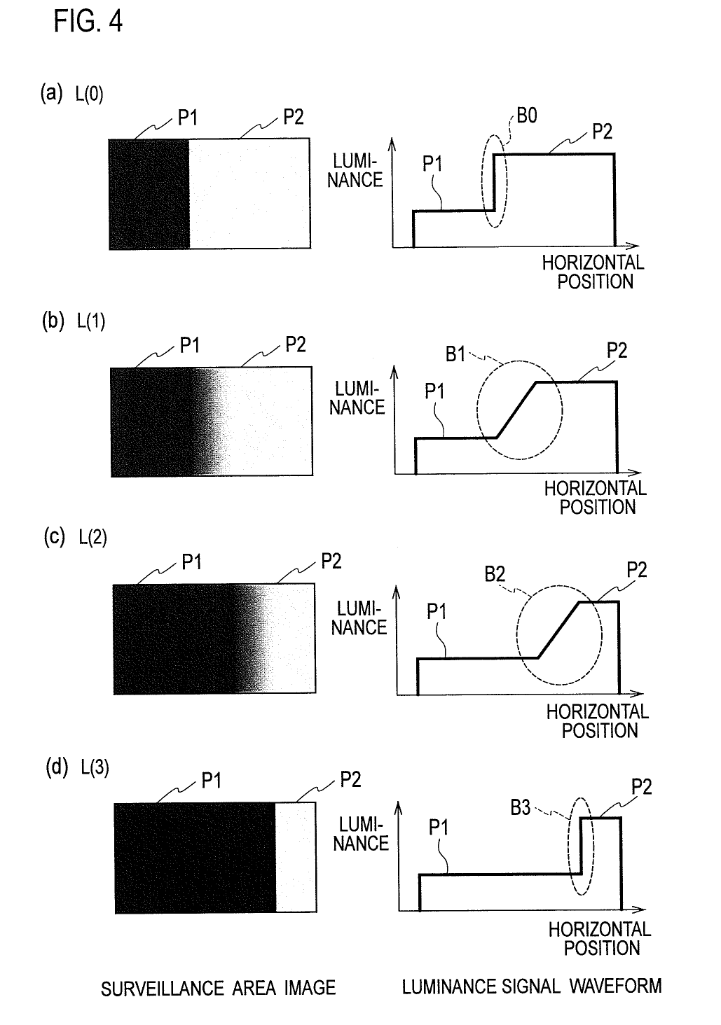

FIG. 4 shows examples of a subject imaged in the surveillance area and luminance signal waveforms obtained by the imaging process. The subject includes a dark part P1 in the left side and a bright part P2 in the right side. The subject remains stationary until the frame 2 in FIG. 3. The dark part P1 in the left side moves to the right at the frames 3 to 6 and then remains stationary again for the frame 7 and the subsequent frames.

In the image signal L(0) (shown in (a) of FIG. 4) which is obtained by imaging the stationary subject, the boundary between the dark and bright parts P1 and P2 of the subject is clearly imaged. The luminance signal Y20 therefore includes a large amount of high-frequency components at the boundary B0 surrounded by a dashed ellipse.

In the image signal L(1) shown in (b) of FIG. 4 and the image signal L(2) shown in (c) of FIG. 4, which are obtained by imaging the moving subject, the image of the boundary between the dark and bright parts P1 and P2 blurs. Accordingly, the high-frequency components of the luminance signal Y20 at the boundaries B1 and B2 surrounded by dashed ellipses are smaller than those included at the boundary BO of the image signal L(0).

In the image signal L(3) (shown in (d) of FIG. 4) which is obtained by imaging the stationary subject, the luminance signal Y20 includes a large amount of high-frequency components at the boundary B3 surrounded by a dashed ellipse, and the high-frequency components at the boundary B3 are larger than those included at the boundary B2 of the image signal L(2).

As described above, the high-frequency components included in the bright signal Y20 increase or decrease depending on whether the subject remains stationary or is moving.

Accordingly, even if the surveillance device illustrated in FIG. 1 operates only in the long-exposure mode, based on a change in the high-frequency components included in the luminance signal Y20, the surveillance device can detect a change in the image due to a change from the state where the subject in the surveillance area remains stationary to the state where the subject is moving.

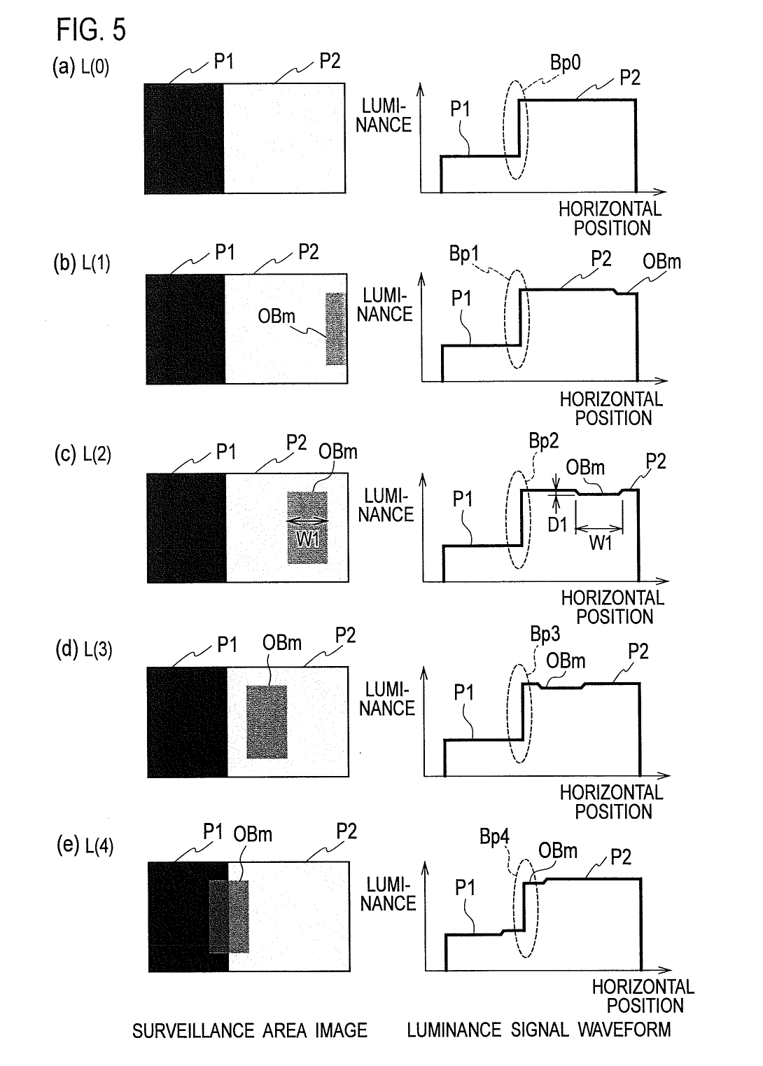

However, when the background remains stationary around the subject and a certain object enters the surveillance area and moves, the surveillance device illustrated in FIG. 1 cannot detect a change in the image of the surveillance area in some cases. This is described using FIG. 5.

As illustrated in FIG. 5, a subject in the surveillance area includes a dark part P1 in the left side and a bright part P2 in the right side as the background. The background remains stationary, and an object OBm which is brighter than the dark part P1 and is darker than the bright part P2 moves from the right to the left in front of the background in the surveillance area.

In this case, as shown in (a) to (e) of FIG. 5, in the image signals L(0) to L(4), the luminance signals Y20 include large amounts of high-frequency components at boundaries Bp0 to Bp4 surrounded by dashed ellipses, respectively.

An apparent width W1 of the object OBm on the images by the image signals L(2) to L(4) of (c) to (e) of FIG. 5 is larger than an actual width WO and is expressed by Equation (1).

W1=W0+V×T1 (1)

where W0 is an actual horizontal width of the moving object OBm, V is a horizontal moving velocity, and T1 is an exposure time period.

Since the apparent width W1 of the object OBm is larger than the actual width W0, a decrease of D1 in luminance is small as illustrated in (c) of FIG. 5. Accordingly, the high-frequency components at the boundary between the object OBm and the background change very little, and there is very little difference in high-frequency components included in the luminance signal Y20 between the image signal L(0) before the object OBm enters the background and the image signal L(1) and subsequent image signals after the object OBm enters the background. Accordingly, in the case of FIG. 5, the change in the image of the surveillance area cannot be detected.

In order to increase the accuracy in detecting a change in the image of the surveillance area, therefore, the surveillance device of the first embodiment is configured as illustrated in FIGS. 1 and 2 described above and is caused to operate as follows.

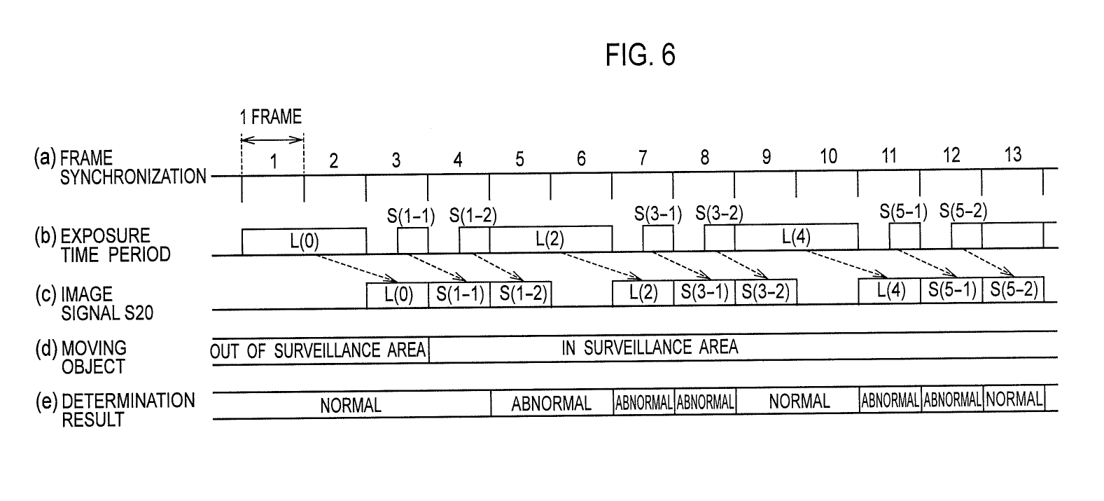

In FIG. 6, (a) shows frame synchronization; (b), the exposure time periods; and (c), the image signal S20 outputted from the signal processing unit 20.

As shown in (b) of FIG. 6, in the surveillance device of the first embodiment, image signals L(0), L(2), L(4) . . . obtained through exposure in the long-exposure mode and image signals S(1-1), S(1-2), S(3-1), S(3-2), S(5-1), S(5-2) . . . obtained through exposure in the short-exposure mode are mixed. The image signals L(0) to L(4) and the image signals S(1-1) to S(5-2) are image signals of the frames constituting the image signal S20.

Specifically, as shown in (b) and (c) of FIG. 6, the image signal L(0) obtained through exposure for a time period of the two frames 1 and 2 is outputted at the time of the frame 3. The image signal S(1-1) obtained through exposure for a time period within the single frame 3 is then outputted at the time of the frame 4, and the image signal S(1-2) obtained through exposure for a time period of the single frame 4 is then outputted at the time of the frame 5.

The image signal L(2) obtained through exposure for a time period of the two frames 5 and 6 is outputted at the time of the frame 7. The image signal S(3-1) obtained through exposure for a time period within the single frame 7 is then outputted at the time of the frame 8, and the image signal S(3-2) obtained through exposure for a time period within the single frame 8 is then outputted at the time of the frame 9. Hereinafter, the same operation is repeated.

As described above, in the surveillance device of the first embodiment, the signal processing unit 20 is configured to alternately and repeatedly output one image signal obtained through exposure in the long-exposure mode and two image signals obtained through exposure in the short-exposure mode. In FIG. 6, the exposure time period of the short exposure mode in the frames 3, 4, 7, 8, 11, 12 . . . is set to a time period of 0.5 frames as an example.

The signal processing unit 20 may be configured to alternately and repeatedly output one image signal obtained through exposure in the long-exposure mode and one image signal obtained through exposure in the short-exposure mode. In other words, the signal processing unit 20 only needs to alternately and repeatedly output a group of one or a plurality of image signals obtained through exposure in the long-exposure mode and a group of one or a plurality of image signals obtained through exposure in the short-exposure mode.

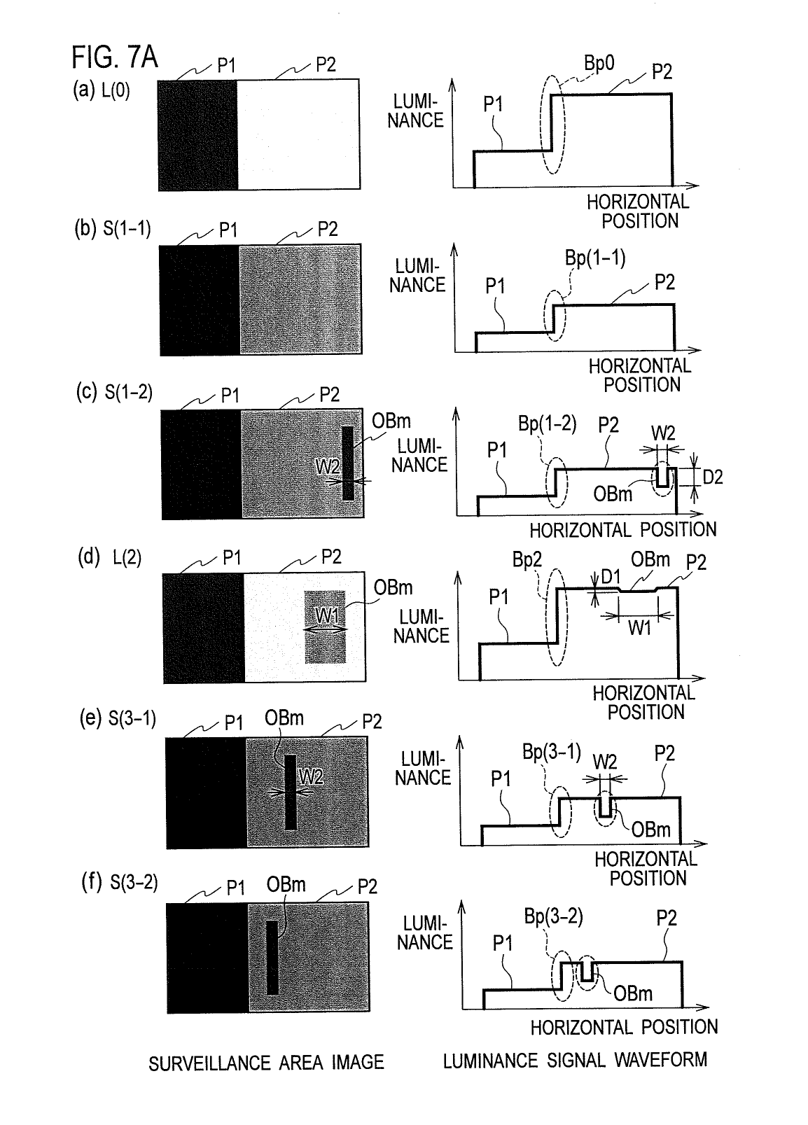

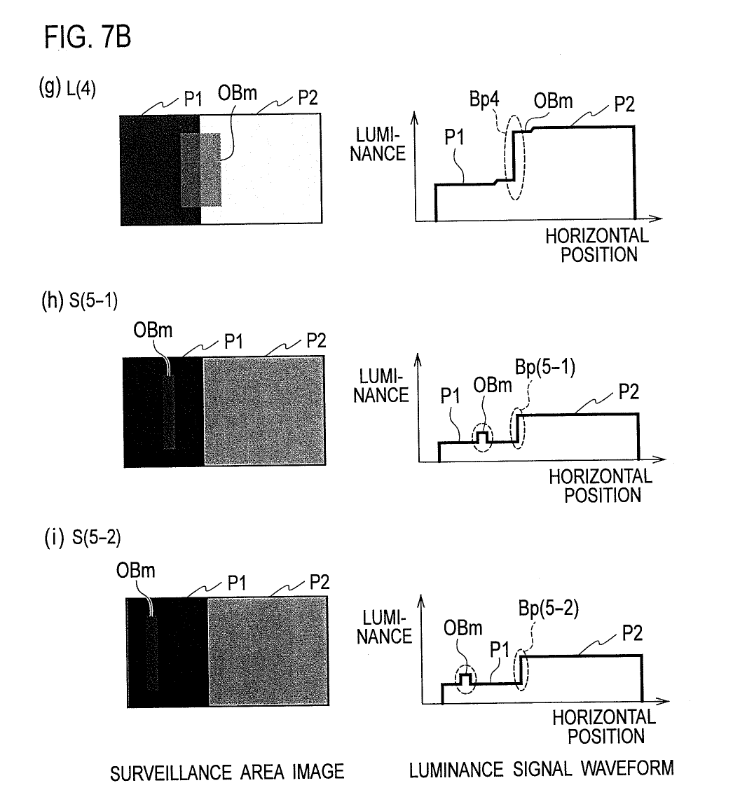

A description is given of the way how the surveillance device of the first embodiment operates when the object OBm moves from the right to the left in front of the background including a dark part P1 and a bright part P2 in the surveillance area as illustrated in FIGS. 7A and 7B similarly to FIG. 5. Herein, the object OBm is brighter than the dark part P1 and darker than the bright part P2.

In FIG. 2, the gain controller 301 sequentially receives luminance signals of the image signal L(0) shown in (a) of FIG. 7A, the image signal S(1-1) shown in (b), and the image signal shown in (c) and the subsequent image signals.

The image signal L(0) is an image signal obtained by imaging in the long-exposure mode and has a luminance signal waveform as illustrated in (a). The image signal S(1-1) is an image signal obtained by imaging in the short-exposure mode and has the same luminance signal waveform as the image signal L(0) but with the luminance amplitude reduced.

When the luminance signal of the image signal L(0) obtained by imaging in the long-exposure mode is multiplied by a predetermined gain of less than 1, the obtained signal has substantially the same amplitude as that of the luminance signal of the image signal S(1-1) obtained by imaging in the short-exposure mode.

When the luminance signal of the image signal S(1-1) obtained by imaging in the short-exposure mode is multiplied by a predetermined gain of more than 1, the obtained signal has substantially the same amplitude as that of the luminance signal of the image signal L(0) obtained by imaging in the long-exposure mode. When the luminance amplitudes are set equal to each other in such a manner, an increase or decrease in high-frequency components can be detected.

In the first embodiment, the exposure time period of the short-exposure mode is set to a period of 0.5 frames, and the exposure time period of the long-exposure mode is set to a period of two frames. The gain controller 301 adjusts the luminance amplitudes of the image signals L(0), L(2), L(4), . . . , which are obtained by imaging in the long-exposure mode by multiplying the luminance signals of the image signals L(0), L(2), L(4), . . . by a gain of 0.25 as an example so that the amplitude of the luminance signals of the image signals L(0), L(2), L(4), . . . is equal to that of the luminance signals of the image signals S(1-1), S(1-2), S(3-1), S(3-2), S(5-1), S(5-2), . . . .

The high-frequency detector 302 detects the amount of high-frequency components of the luminance signals of the image signals L(0), L(2), L(4), . . . which are gain-controlled by the gain controller 301 and the luminance signals of the image signals S(1-1), S(1-2), S(3-1), S(3-2), S(5-1), S(5-2), . . . . The amount of high-frequency components detected by the high-frequency detector 302 is inputted to the storage portion 303 to be temporarily stored and is then delayed by a period of one frame to be inputted into the comparison and determination portion 304.

The comparison and determination portion 304 compares the amount of high-frequency components of the current frame outputted from the high-frequency detector 302 with the amount of high-frequency components of the previous frame which is outputted from the storage portion 303.

The high-frequency detector 302 detects at the time of the frame 3, the amount of high-frequency components at the boundary Bp0 surrounded by the dashed ellipse in the image signal L(0) shown in (a) of FIG. 7A. To be strict, the high-frequency detector 302 detects the high-frequency components of the image signal L(0) gain-controlled as described above. However, the following description is given assuming that the high-frequency detector 302 detects the amounts of high-frequency components in the luminance signal waveforms shown in FIGS. 7A and 7B for simplification of description.

The high-frequency detector 302 detects the amount of the high-frequency components at the boundary Bp(1-1) surrounded by a dashed ellipse in the image signal S(1-1) shown in (b) of FIG. 7A at the time of the frame 4.

The comparison and determination portion 304 compares the amount of high-frequency components at the boundary Bp0 with the amount of high-frequency components at the boundary Bp (1-1), which are substantially equal to each other. Accordingly, the comparison and determination portion 304 determines that the image of the surveillance area has not changed and there is no abnormality.

In this description, the high-frequency detector 302 detects the amounts of high-frequency components in the one-dimensional horizontal direction for easy understanding. Generally, the amount of high-frequency components is detected based on the integrated values of second spatial derivatives obtained by using a Laplacian filter.

Next, the high-frequency detector 302 detects the amount of high-frequency components included in the image signal S(1-2) shown in (c) of FIG. 7A at the time of the frame 5. Herein, the image signal S(1-2) is obtained by imaging in the short-exposure mode, and a horizontal apparent width W2 of the moving object OBm is about a quarter of the width W1 of the object OBm on the image obtained by imaging in the long-exposure mode based on Equation (1). A decrease D2 in luminance is therefore increased.

Accordingly, in the image signal S(1-2), the high-frequency detector 302 detects the high-frequency component at the outline of the object OBm surrounded by a dashed ellipse in addition to the high-frequency component at the boundary Bp(1-2) surrounded by a dashed ellipse.

The comparison and determination portion 304 therefore detects at the time of the frame 5 that the amount of high-frequency components included in the image signal S(1-2) is larger by a predetermined threshold value or more than the amount of high-frequency components included in the image signal S(1-1).

Based on the increase in the amount of high-frequency components, the comparison and determination portion 304 determines that the image of the surveillance area has changed and there is an abnormality. The abnormality signal generator 305 then generates an abnormality signal.

The drive control setting signal generator 306 generates a drive control setting signal for setting the short-exposure mode only for a predetermined time period of frames and supplies the same to the drive controller 40 so that the outline of the object OBm can be precisely recognized.

The high-frequency detector 302 detects the amount of high-frequency components included in the image signal L(2) shown in (d) of FIG. 7A at the time of the frame 7. Since the image signal L(2) is obtained by imaging in the long-exposure mode, the obtained image of the object OBm has a width W1, and the decrease in luminance is a decrease of D1 smaller than the decrease of D2.

Accordingly, the high-frequency detector 302 detects only the amount of high-frequency components at the boundary Bp2 surrounded by a dashed ellipse in the image signal L(2) at the time of the frame 7. The comparison and determination portion 304 therefore detects that the amount of high-frequency components included in the image signal L(2) is smaller by a predetermined threshold value or more than the amount of high-frequency components included in the image signal S(1-2).

Based on the decrease in amount of high-frequency components, the comparison and determination portion 304 determines that the image of the surveillance area has changed and there is an abnormality. The abnormality signal generator 305 generates an abnormality signal.

As described above, the comparison and determination portion 304 determines that the image of the surveillance area has changed when the amount of high-frequency components detected from an image signal obtained by imaging in the short-exposure mode is larger by a predetermined threshold value or more than the amount of high-frequency components detected from the image signal obtained by imaging at the previous frame. Herein, the previous frame may be either the frame at which the image signal is obtained by imaging in the short-exposure mode or the frame at which the image signal is obtained by imaging in the long-exposure mode.

Moreover, the comparison and determination portion 304 determines that the image of the surveillance area has changed when the amount of high-frequency components detected from an image signal obtained by imaging in the long-exposure mode is smaller by a predetermined threshold value or more than the amount of high-frequency components detected from the image signal obtained by imaging at the previous frame. The previous frame herein may be either the frame at which the image signal is obtained by imaging in the short-exposure mode or the frame at which the image signal is obtained by imaging in the long-exposure mode.

In a similar manner, at the time of the frame 8, the high-frequency detector 302 detects the amount of high-frequency components at the outline of the object OBm surrounded by a dashed ellipse in addition to the amount of high-frequency components at the boundary Bp(3-1) surrounded by a dashed ellipse in the image signal S(3-1) shown in (e) of FIG. 7A.

The comparison and determination portion 304 detects that the amount of high-frequency components included in the image signal S(3-1) is larger by a predetermined threshold value or more than the amount of high-frequency components included in the image signal L(2) and determines that the image of the surveillance area has changed and there is an abnormality.

The amount of high-frequency components which is included in the image signal S(3-2) shown in (f) of FIG. 7A and is detected at the time of the frame 9 by the high-frequency detector 302 includes the amount of high-frequency components at the boundary Bp(3-2) and the amount of high-frequency components at the outline of the object OBm and is substantially equal to the amount of high-frequency components included in the image signal S(3-1). The comparison and determination portion 304 therefore determines that the image of the surveillance area has not changed and there is no abnormality.

Subsequently, at the time of the frame 11, the high-frequency detector 302 detects only the amount of high-frequency components at the boundary Bp4 surrounded by a dashed ellipse in the image signal L(4) shown in (g) of FIG. 7B.

The comparison and determination portion 304 detects that the amount of high-frequency components included in the image signal L(4) is smaller by the predetermined threshold value or more than the amount of high-frequency components included in the image signal S(3-2) and determines that there is an abnormality.

At the time of the frame 12, the high-frequency detector 302 detects the amount of high-frequency components at the boundary Bp(5-1) included in the image signal S(5-1) shown in (h) of FIG. 7B and the amount of high-frequency components at the outline of the object OBm.

The comparison and determination portion 304 detects that the amount of high-frequency components included in the image signal S(5-1) is smaller by the predetermined threshold value or more than the amount of high-frequency components included in the image signal L(4) and determines that there is an abnormality.

At the time of the frame 13, the high-frequency detector 302 detects the amount of high-frequency components at the boundary Bp(5-2) and the amount of high-frequency components at the outline of the object OBm which are included in the image signal S(5-2) shown in (i) of FIG. 7B. The amount of high-frequency components included in the image signal S(5-2) is substantially equal to the amount of high-frequency components included in the image signal S(5-1). The comparison and determination portion 304 therefore determines that there is no abnormality.

Similarly in the subsequent frames, in a state where the image of the surveillance area is changing, it is determined that there is an abnormality when the image signal obtained by imaging in the long-exposure mode and the first one of two successive image signals obtained by imaging in the short-exposure mode are inputted into the comparison and determination portion 304.

(d) of FIG. 6 shows whether the moving object OBm is in the surveillance area. (e) of FIG. 6 shows the normal and abnormal states determined as described above.

As shown in (c) of FIG. 6, the signal processing unit 20 does not output an image signal at the frames 6, 10 . . . Accordingly, in the frames at which no image signal is outputted, the comparison and determination portion 304 does not update the determination results of the previous frame.

If the operation of imaging in the long-exposure mode and the operation of imaging in the short-exposure mode are alternately performed, which is not particularly illustrated, it is determined that there is an abnormality also at the times of the frames 9 and 10, further increasing the accuracy in detecting a change in the image of the surveillance area.

The surveillance device of the first embodiment can detect a change in not only the image in which the object Obm is moving in front of the background as shown in FIGS. 7A and 7B but also in an image which includes a dark part P1 and a bright part P2 and in which the dark part P1 is moving in a similar manner to FIG. 4.

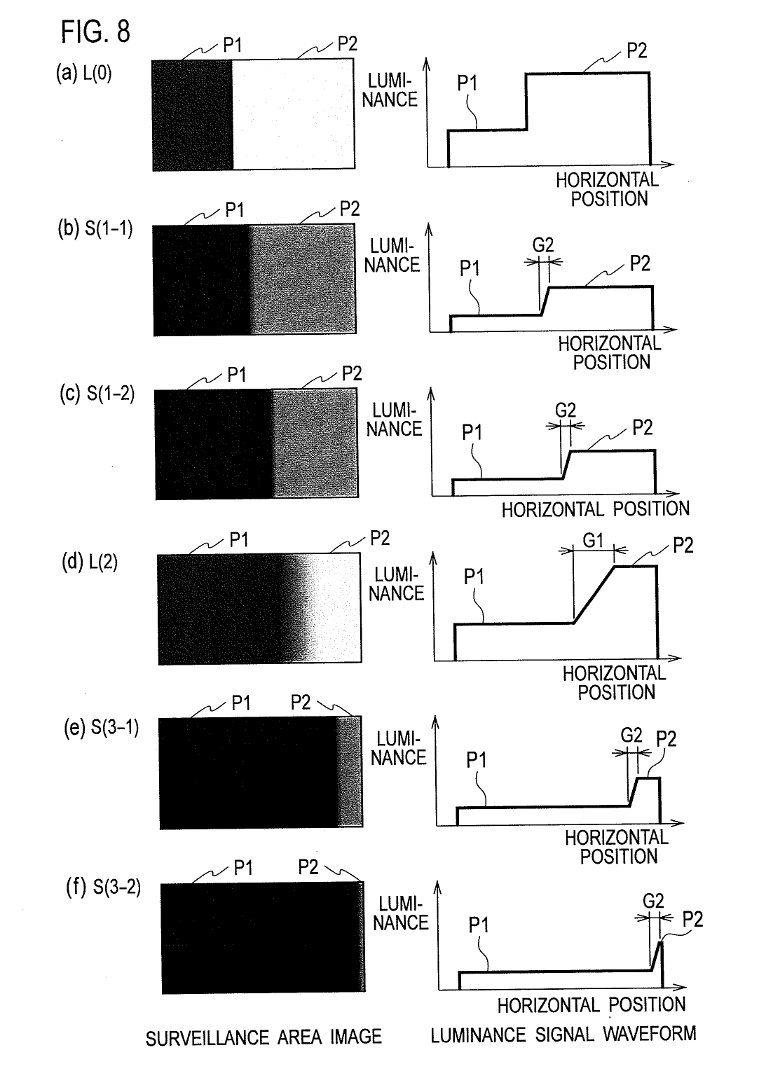

Using FIG. 8, a description is given of the operation of the surveillance device of the first embodiment in the case where a subject includes a dark part P1 and a bright part P2 and in which the dark part P1 moves to the right. The subject remains stationary until the frame 2 in FIG. 6 and moves to the right at the frame 3 and subsequent frames.

In the image signals S(1-1) and S(1-2) (shown in (b) and (c) of FIG. 8) which are obtained by imaging in the short-exposure mode, the boundary between the dark and bright parts P1 and P2 moves little, and a width G2 of blur at the boundary is narrow. Accordingly, the high-frequency detector 302 detects a comparatively large amount of high-frequency components from all of the image signal L(0) shown in (a) of FIG. 8 and the image signals S(1-1) and S(1-2) shown in (b) and (c) of FIG. 8.

The comparative determination unit 304 therefore does not detect differences in the amount of high-frequency components between the image signals L(0) and S(1-1) and between the image signal S(1-1) and S(1-2) and determines that there is no abnormality.

In the image signal L(2) obtained by imaging in the long-exposure mode shown in (d) of FIG. 8, the boundary between the dark and bright parts P1 and P2 moves a lot, and a width G1 of blur at the boundary is wide. Accordingly, the high-frequency detector 302 detects a comparatively small amount of high-frequency components from the image signal L(2).

Accordingly, the comparison and determination portion 304 detects a decrease in the amount of high-frequency components from the image signal S(1-2) to the image signal L(2) and determines that there is an abnormality.

In the image signal S(3-1) obtained by imaging in the short-exposure mode shown in (e) of FIG. 8, the high-frequency detector 302 detects a large amount of high-frequency components again. The comparison and determination portion 304 detects an increase in the amount of high-frequency components from the image signal L(2) to the image signal S(3-1) and determines that there is an abnormality.

In the image signal S(3-2) obtained by imaging in the short-exposure mode shown in (f) of FIG. 8, the comparison and determination portion 304 dose not detect an increase or decrease in the amount of high-frequency components between the image signal S(3-1) and the image signal S(3-2) and determines that there is no abnormality.

Also in the case of FIG. 8, it is determined that there is an abnormality when the image signal obtained by imaging in the long-exposure mode and the first one of two successive image signals obtained by imaging in the short-exposure mode are inputted into the comparison and determination portion 304 after the image of the surveillance area changes.

### Second Embodiment

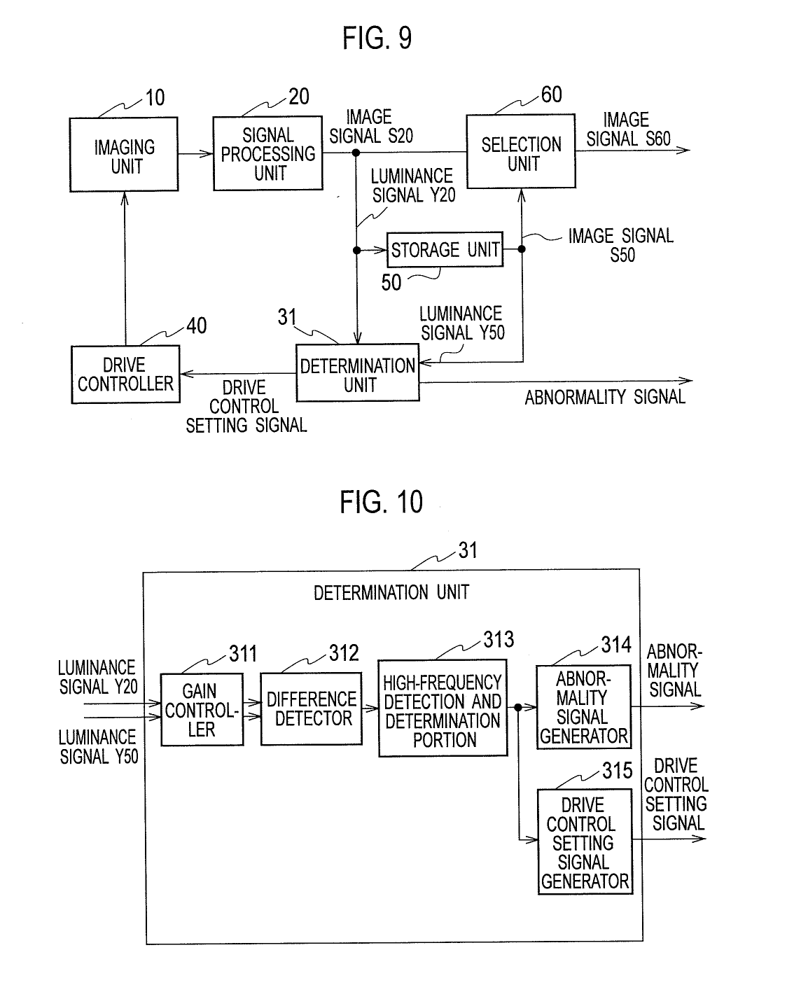

In a surveillance device of a second embodiment illustrated in FIG. 9, the same portions as those of FIG. 1 are given the same reference numerals, and the description thereof is properly omitted.

In FIG. 9, the image signal S20 outputted from the signal processing unit 20 is inputted to a determination unit 31, a storage unit 50, and a selection unit 60. The storage unit 50 temporarily stores the image signal S20 and outputs the image signal S20 delayed by a time period of one frame as an image signal S50. The image signal S50 is inputted to the determination unit 31 and the selection unit 60.

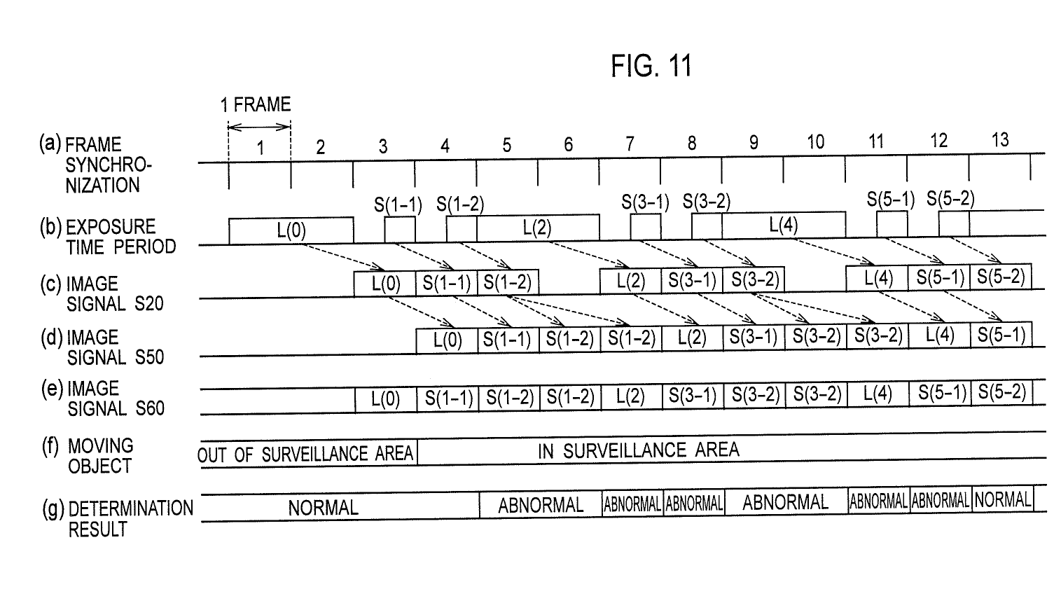

In FIG. 11, (a) shows frame synchronization; (b), the exposure time period; and (c), the image signal S20 outputted from the signal processing unit 20, which are the same as those of (a) to (c) of FIG. 6.

In FIG. 11, (d) shows the image signal S50 outputted from the storage unit 50. At the times of the frames 6, 10, . . . , the image signal S20 is not outputted, and the image signal S20 stored in the storage unit 50 is not updated. Accordingly, the image signals S20 written at the times of the frames 5, 9, . . . , are outputted from the storage unit 50 at two successive frames.

The selection unit 60 selects the image signal S20 at the time of the frame at which the image signal S20 is outputted from the signal processing unit 20 and selects the image signal S50 at the time of the frame at which the image signal S20 is not outputted from the signal processing unit 20. The selection unit 60 then outputs the image signal S60 shown in (e) of FIG. 11.

As illustrated in FIG. 10, the determination unit 31 includes a gain controller 311, a difference detector 312, a high-frequency detection and determination portion 313, an abnormality signal generator 314, and a drive control setting signal generator 315.

The gain controller 311 receives the luminance signal Y20 of the image signal S20 and a luminance signal Y50 of the image signal S50. The operation of the gain controller 311 is the same as that of the gain controller 301 of FIG. 2. The gain controller 311 multiplies the luminance signal obtained by imaging in the long-exposure mode by a gain of 0.25 to set the magnitude of the luminance amplitude thereof equal to that of the luminance signal obtained by imaging in the short-exposure mode.

The difference detector 312 reduces the luminance signal Y50 from the luminance signal Y20 whose magnitudes of the amplitudes of the luminance signals Y50 and Y20 are set equal to each other to detect a difference between the luminance signals Y20 and Y50. The detected difference is inputted to the high-frequency detection and determination portion 313.

The high-frequency detection and determination portion 313 detects the amount of high-frequency components based on the inputted difference. The high-frequency detection and determination portion 313 determines that the image of the surveillance area has changed and there is an abnormality when the amount of high-frequency components is equal to or larger than a predetermined threshold value.

When the high-frequency detection and determination portion 313 determines that there is an abnormality, the abnormality signal generator 314 generates an abnormality signal, and the drive control setting signal generator 315 generates a drive control setting signal if necessary.

The abnormality signal generator 314 is substantially the same as the abnormality signal generator 305, and the drive control setting signal generator 315 is substantially the same as the drive control setting signal generator 306.

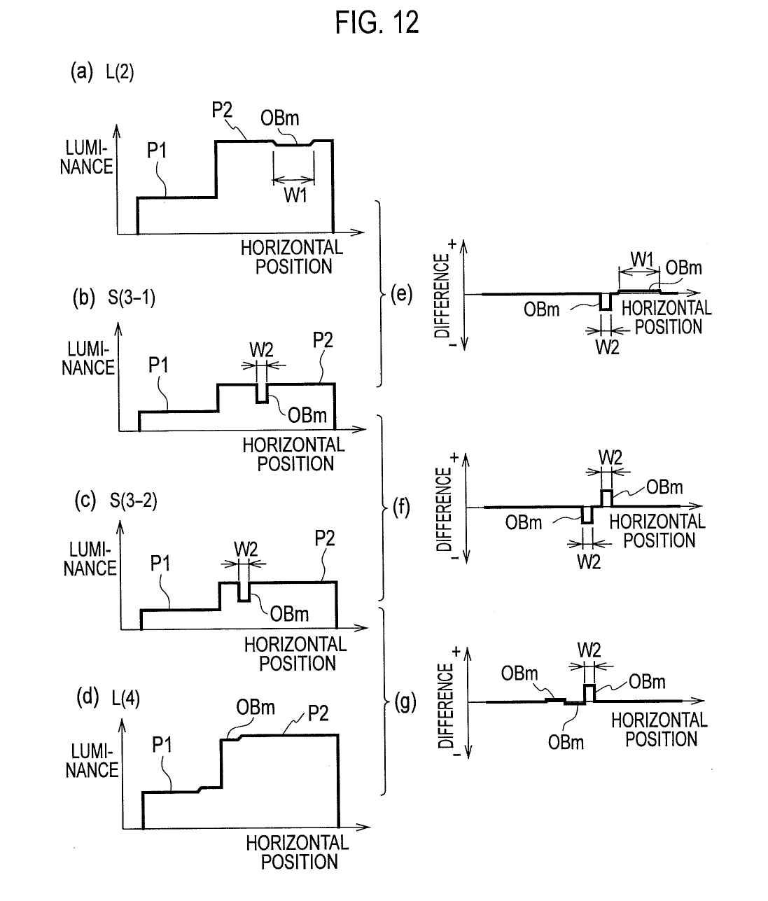

A description is given of the concrete operation of the surveillance device of the second embodiment using FIG. 12. (a) to (d) of FIG. 12 show luminance signal waveforms of the image signals L(2), S(3-1), S(3-2), and L(4) shown in (d) to (f) of FIG. 7A and (g) of FIG. 7B.

The difference detector 312 outputs a difference obtained by reducing the image signal L(2) shown in (a) of FIG. 12 from the image signal S(3-1) shown in (b) of FIG. 12 at the time of the frame 8 of FIG. 11. The image signals L(2) and S(3-1) have substantially the same luminance at the background other than the object OBm because of the gain-control by the gain controller 311.

As shown in (e) of FIG. 12, therefore, the obtained difference waveform protrudes into the positive side with a width W1 and into the negative side with a width W2 only in the portions corresponding to the object OBm.

In the waveform shown in (e) of FIG. 12, the amount of high-frequency components detected at the portion corresponding to the object OBm which protrudes into the negative side with a width W2 is equal to or larger than the predetermined threshold value. Accordingly, the high-frequency detection and determination portion 313 determines that the image of the surveillance area has changed and there is an abnormality.

At the time of the frame 9 of FIG. 11, the difference detector 312 outputs a difference obtained by reducing the image signal S(3-1) shown in (b) of FIG. 12 from the image signal S(3-2) shown in (c) of FIG. 12. In this case, as shown in (f) of FIG. 12, the difference waveform protrudes into both the positive and negative sides only in the portions corresponding to the object OBm with the width W2.

In the waveform shown in (f) of FIG. 12, the amount of high-frequency components detected at the portions corresponding to the object OBm which protrude into both the positive and negative sides with the width W2 is equal to or larger than the predetermined threshold value. Accordingly, the high-frequency detection and determination portion 313 determines that the image of the surveillance area has changed and there is an abnormality.

At the time of the frame 10 of FIG. 11, the image signal S20 is not outputted. Accordingly, the high-frequency detection and determination portion 313 does not update the determination results at the time of the frame 9 and maintains the same.

The difference detector 312 outputs a difference obtained by reducing the image signal S(3-2) shown in (c) of FIG. 12 from the image signal L(4) shown in (d) of FIG. 12 at the time of the frame 11 of FIG. 11. In this case, as shown in (g) of FIG. 12, the waveform of the difference protrudes into the positive side with the width W2 and protrudes into the positive and negative sides with a half of the width W2 each only in the portions corresponding to the object OBm.

In the waveform shown in (g) of FIG. 12, the amount of high-frequency components detected at the portion corresponding to the object OBm which protrudes into the positive side with the width W2 is equal to or larger than the predetermined threshold value. Accordingly, the high-frequency detection and determination portion 313 determines that the image of the surveillance device has changed and there is an abnormality.

(f) of FIG. 11 shows whether the moving object OBm is in the surveillance area. (g) of FIG. 11 shows the normal and abnormal states determined as described above.

In the second embodiment, it is determined that there is an abnormality also at the times of the frames 9 and 10 at which it is determined that there is no abnormality in FIG. 6 of the first embodiment.

As described above, in the surveillance device of the first embodiment and the control method thereof, the determination unit 30 shown in FIG. 2 detects changes on a frame-by-frame basis in the amount of high-frequency components included in the luminance signals obtained in the short-exposure mode and the luminance signals obtained in the long-exposure mode whose luminance amplitudes are set equal to each other. When the amount of high-frequency components is different from that of the previous frame by a predetermined value or more, the determination unit 30 determines that the image of the surveillance area has changed.

In the surveillance device of the second embodiment and the control method thereof, the determination unit 31 shown in FIG. 10 detects the amount of high-frequency components included in the difference signal between luminance signals of two successive frames, including the luminance signals obtained in the short-exposure mode and the luminance signals obtained in the long-exposure mode whose luminance amplitudes are set equal to each other. When the detected amount of high-frequency components is equal to or larger than a predetermined value, the determination unit 30 determines that the image of the surveillance area has changed.

According to the surveillance devices of the first and second embodiments and the control method thereof, it is possible to increase the accuracy in detecting a change in the image of the surveillance area under the low-illumination environment.

The present invention is not limited to the first and second embodiments described above and can be variously changed without departing from the scope of the present invention.

The first and second embodiments employ the two exposure modes including: the short-exposure mode with the exposure time period of the imaging device set to a period within one frame; and the long-exposure mode with the exposure time period set to a period of more than one frame. However, it is possible to use three or more exposure modes with the exposure time periods set different from one another.

In other words, the surveillance device needs to image a subject at least at a first exposure mode and a second exposure mode. Herein, in the first exposure mode, the imaging device is exposed for a first exposure time period, and in the second exposure mode, the imaging device is exposed for a second exposure time period which is set longer than the first exposure time period.

The configurations shown in FIGS. 1 and 2 and shown in FIGS. 9 and 10 are just examples of the first and second embodiments, and the specific block configuration (circuit configuration) can be properly changed. In FIGS. 1 and 9, the gain controllers 301 and 311 are provided within the determination units 30 and 31, respectively. However, the gain controllers 301 and 311 may be provided out of the determination units 30 and 31.

What is claimed is:

1. A surveillance device, comprising:
an imaging unit including an imaging device;
a drive controller configured to control the imaging unit so that a subject is imaged at a first exposure mode in which the imaging device is exposed for a first exposure time period and imaged at a second exposure mode in which the imaging device is exposed for a second exposure time period that is longer than the first exposure time period;
a gain controller configured to control a gain of any one of a first luminance signal of a first image signal obtained by imaging the subject in the first exposure mode and a second luminance signal of a second image signal obtained by imaging the subject in the second exposure mode so as to set equal to each other luminance amplitudes of the first and second image signals due to a difference in exposure time period; and
a determination unit configured to detect a change between each frame of high-frequency components included in the first and second luminance signals whose luminance amplitudes are set equal to each other by the gain controller and to determine that the image of a surveillance area has changed when an amount of a detected change is equal to or larger than a predetermined value.

2. The surveillance device according to claim 1, wherein
in the case where a frame of the first luminance signal is a current frame to be determined, the determination unit determines that the image has changed when an amount of high-frequency components detected at the current frame to be determined is smaller than an amount of high-frequency components detected at the previous frame by a predetermined threshold value or more, and
in the case where a frame of the second luminance signal is a current frame to be determined, the determination unit determines that the image has changed when an amount of high-frequency components detected at the current frame to be determined is larger than an amount of high-frequency components detected at the previous frame by a predetermined threshold value or more.

3. The surveillance device according to claim 1, wherein
the determination unit includes:
a high-frequency detector configured to detect an amount of high-frequency components included in each frame of the first and second luminance signals whose luminance amplitudes are set equal to each other by the gain controller;
a storage portion configured to delay the amount of high-frequency components detected by the high-frequency detector by a time period of one frame; and
a comparison and determination portion configured to compare the amount of high-frequency components outputted from the high-frequency detector with the amount of high-frequency components outputted from the storage portion and determine whether the image of the surveillance area has changed.

4. A surveillance device comprising:
an imaging unit including an imaging device;
a drive controller configured to control the imaging unit so that a subject is imaged at a first exposure mode in which the imaging device is exposed for a first exposure time period and imaged at a second exposure mode in which the imaging device is exposed for a second exposure time period that is longer than the first exposure time period;
a gain controller configured to control a gain of any one of a first luminance signal of a first image signal obtained by imaging the subject in the first exposure mode and a second luminance signal of a second image signal obtained by imaging the subject in the second exposure mode so as to set equal to each other luminance amplitudes of the first and second image signals due to a difference in exposure time period;
a difference detector configured to detect a difference between adjacent frames in the first and second luminance signals whose luminance amplitudes are set equal to each other by the gain controller; and
a high-frequency detection and determination portion configured to detect an amount of high-frequency components based on the difference detected by the difference detector and to determine that the image of a surveillance area has changed when the amount of high-frequency components is equal to or larger than a predetermined threshold value.

5. The surveillance device according to claim 1, wherein the drive controller controls the imaging unit so that a group of one or a plurality of frames of the first image signal obtained by imaging in the first exposure mode and a group of one or a plurality of frames of the second image signal obtained by imaging the subject in the second exposure mode are alternately repeated.

6. The surveillance device according to claim 1, wherein the drive controller controls the imaging unit so that the imaging unit images the subject with the first exposure time period set to a period within one frame and the second exposure time period set to a period of more than one frame.

7. A control method of a surveillance device comprising:
imaging a subject in a first exposure mode at which an imaging device is exposed for a first exposure time period and a second exposure mode at which the imaging device is exposed for a second exposure time period that is longer than the first exposure time period;
adjusting a gain of any one of a first luminance signal of a first image signal obtained by imaging the subject at the first exposure mode and a second luminance signal of a second image signal obtained by imaging the subject at the second exposure mode so that luminance amplitudes of the first and second image signals due to a difference in exposure time period are equal to each other; and
detecting a change between each frame of high-frequency components included in the first and second luminance signals whose luminance amplitudes are set equal to each other and determining that the image of a surveillance area has changed when an amount of a detected change is equal to or larger than a predetermined value.
